(19) United States
(12) Patent Application Publication
(10) Pub. No.: US 2009/0261534 A1
(43) Pub. Date: Oct. 22, 2009

(54) SEALING GASKET AND USES OF SUCH A GASKET

(75) Inventor: Sebastien Pradelle, Maisoncelles Du Maine (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Le Joint Francais

(21) Appl. No.: 12/424,994

(22) Filed: Apr. 16, 2009

(30) Foreign Application Priority Data
Apr. 18, 2008 (FR) 08 02176

(51) Int. Cl. F16J 15/02

(52) U.S. Cl. 277/648

(57) ABSTRACT

A gasket of multipurpose design is provided, requiring only simple adjustments of the structure of the gasket as a function of the use that is made thereof, namely for connectors in a fluid circuit or for high-pressure hydraulic pistons. More precisely, there is provided an annular gasket of elastically deformable material presenting an axis of revolution and a transverse axis, and comprising, in cross-section, a central zone of determined thickness presenting an inside face facing towards the axis of revolution, and an opposite outside face, together with two side faces interconnecting the inside and outside faces. At least one of the side faces includes at least one compressible lobe; and one of the outside and inside faces carries two lips suitable for bending, that are arranged on either side of the transverse axis, and each of which is connected to a respective one of the side faces.

### CROSS REFERENCE TO RELATED APPLICATIONS

This application claims priority from French Application No. 08 02176, filed Apr. 18, 2008.

### FIELD OF THE INVENTION

The present invention relates to an improved sealing gasket and to uses of such a gasket.

### BACKGROUND OF THE INVENTION

The automobile industry is faced with numerous technical problems involving gaskets.

A first problem arises with the arrival of new environmental standards that require great reductions in leakage rates, e.g. from fluid circuits, tanks, etc. One component of such leakage is due to the fluid that needs to be sealed leaking past sealing gaskets. Certain applications are particularly concerned because the measured leakage is due essentially to leakage past a sealing gasket. By way of example, the applications in question are: the fuel circuit (sealing the tank, connection, etc.); the urea circuit; air conditioning; or any other application where the fluid may be in the gas phase. Certain applications are more critical because of the sizes of connectors, such as providing sealing for the tank or the gasket for the tank filler tube.

A connector comprises a male part and a female part. The sealing gasket presents an axis of revolution R and transverse axis T. The gasket is generally mounted in an open groove of the male part to be squeezed axially against a shoulder of the female part, i.e. to be squeezed substantially parallel to the axis of revolution R. Thus, a proximal portion of the gasket, i.e. a portion closer to the center of the gasket, comes into contact with the bottom of the groove in the male part. The distal portion of the gasket, i.e. the portion further from the center of the gasket, comes into contact with the female part.

Squeezing thus comprises a component that is essentially axial, i.e. substantially parallel to the axis of revolution R. In practice, given dimensional tolerances that are sometimes large, the squeezing also includes a radial component that is not negligible. In other words, when the two connector portions are moved towards each other axially, they may be shifted radially, i.e. substantially parallel to the transverse axis.

Numerous parts of such circuits are made of plastics material, and in particular the parts that are for receiving the sealing gasket. It is therefore not possible to improve the sealing of such circuits by increasing the extent to which gaskets are compressed, without running the risk of deforming or damaging such parts made of plastics material. The consequence of such compression would be to lose sealing, i.e. to increase leakage.

The gaskets that are most commonly used in such connectors are O-rings because of their low cost. Nevertheless, coupling a connector fitted with such a gasket requires a considerable amount of force, in particular with increasing gasket size and/or with the gasket being squeezed more tightly.

O-rings also present the drawback of being sensitive to the “roll-back” phenomenon. When mounted in a groove for axial squeezing, an O-ring is generally subjected to a small amount of extension, which has the effect of making it unstable in the groove. Given the considerable dimensional tolerances, if the groove does not present sufficient height, then the small amount of gasket extension combined, for example, with vibration in the assembly line, can lead to the O-ring twisting, and that can cause it to roll back out from the groove. The parts can then no longer be coupled and the assembly needs to be removed from the assembly line. Furthermore, the O-ring no longer satisfies requirements in terms of leaktightness.

An improvement consists in making a gasket of D-shaped profile, thereby limiting the roll-back phenomenon since the plane portion of the D-shaped gasket is pressed against the bottom of the groove. Nevertheless, the forces required to flatten the gasket remain high. In addition, such a gasket is sensitive to a tipping phenomenon whenever squeezing includes a radial component that is not negligible. Thus, during the squeezing stage, a D-shaped gasket can tip in the groove so that its plane portion comes to face the part that is not carrying the gasket, thereby reducing the pressure force on the gasket, and consequently the sealing of the assembly.

Conventional lip gaskets or section members generally present high fabrication costs, and they require housings that are complex. Furthermore, the fineness of the lips makes them more sensitive to aging.

Finally, proposals have also been made for a gasket of H-shaped profile and that is insensitive to the roll-back phenomenon. Theoretically it does not twist during assembly. Its drawbacks are cost, and the high forces required for flattening the gasket during assembly.

Another technical problem relates to improving radial sealing of a high-pressure hydraulic piston while in use, and in improving the return of the piston to its initial position.

Such a problem arises with a hydraulic actuator for squeezing brake pads against the disk of the wheel. A piston is moved in a chamber from a rest position to a braking position.

A gasket is mounted to be radially squeezed in a groove in the chamber so as to provide hydraulic sealing and prevent the hydraulic liquid escaping from the chamber during braking. With such an assembly, the proximal portion of the gasket, i.e. the portion closer to the center of the gasket, comes into contact with the piston (male part). The distal portion of the gasket, i.e. the portion further away from the center of the gasket, is in contact with the bottom of the groove in the chamber (female part). The squeezing of the gasket between the chamber and the piston is essentially radial, i.e. substantially parallel to the transverse axis T.

When the driver presses on the brake pedal, that increases the hydraulic pressure, and the piston moves, pressing the brake pads against the disk of the wheel. During this stage, the gasket is subjected to high levels of radial pressure, that may be greater than 70 bars.

When the driver releases the brake pedal, hydraulic pressure decreases, and the piston moves back into the chamber towards its initial position so as to move the pads away from the disk of the wheel.

Nevertheless, under certain circumstance, the piston does not move back correctly and the pads can remain in contact with the disk of the wheel, even if such contact is light. This leads to early wear of the pads and of the disk, and can lead to an increase in fuel consumption.

This phenomenon is to be encountered with the assemblies used in the prior art. They comprise a gasket of rectangular section and a chamfered groove. Such a groove is expensive to fabricate. Furthermore, piston return is not always effective.

There thus exists a need to solve these two technical problems. If possible, this should be done while limiting design and production costs.

### OBJECT AND SUMMARY OF THE INVENTION

An object of the invention is thus to provide a gasket of multipurpose design, capable of solving both of the above technical problems, requiring only simple adjustment to the structure of the gasket as a function of the use to which it is to be put, i.e. a gasket mounted for axial squeezing in fluid circuit connectors, or a gasket mounted for radial squeezing in high-pressure hydraulic actuators.

The purpose of the sealing gasket is to improve the leaktightness of connectors, without increasing the forces required for squeezing the sealing gasket while it is being assembled, and improving the leaktightness of high-pressure hydraulic actuators, while also ensuring effective return of the piston to its rest position.

For this purpose, the invention provides a gasket combining compression zones and bending zones, with buffer-forming zones being provided therebetween to oppose the passage of fluid, i.e. zones that slow down or even prevent fluid diffusing between the gasket and the mechanical parts, by reducing the pressure of the fluid.

More precisely, the present invention provides an annular gasket of elastically deformable material presenting an axis of revolution and a transverse axis, and comprising, in cross-section, a central zone of determined thickness, presenting an inside face facing towards the axis of revolution, an outside face opposite therefrom, and two side faces interconnecting the inside and outside faces, wherein:

at least one of the side faces includes at least one compressible lobe; and

one of the outer and inner faces carries two lips suitable for bending that are arranged on either side of the transverse axis and each of which is connected to a respective one of the side faces.

In preferred embodiments:

the inside face may carry the two lips suitable for bending that are arranged on either side of the transverse axis and each of which is connected to a respective one of the side faces;

the outside face may carry the two lips suitable for bending that are arranged on either side of the transverse axis and each of which is connected to a respective one of the side faces;

both lips and said at least one lobe may present respective determined nominal heights relative to the transverse axis of the gasket, the nominal height of at least one of the lips being greater than the nominal height of said at least one lobe;

the gasket may have at least two lobes of different heights;

each side face may carry a respective lobe arranged so that a space is provided between the lobe and a respective one of the lips so as to enable the lobe to be compressed by material creep;

said at least one lobe may be located at a determined minimum distance from the inside or outside face that does not carry the lips;

the gasket may include flash in a mold-separation plane, the flash being disposed substantially parallel to the transverse axis of the gasket; and/or

the inside or outside face that does not carry the lips may be substantially plane or concave.

The invention also provides the use of a gasket of the invention, in a device for connecting together two pipes for a fluid at a determined pressure, the pipes being placed in an outside medium at a predetermined pressure, the connection device comprising a male part and a female part, wherein the gasket is mounted to be squeezed axially in a groove of determined width in the male part, in such a manner that:

if the pressure of the outside medium is greater than the pressure of the fluid, the two lips are carried by the outside face and the inside face is in contact with the bottom of the groove in the male part; and

if the pressure of the fluid is greater than the pressure of the outside medium, the two lips are carried by the inside face and are in contact with the bottom of the groove in the male part.

In preferred uses:

the ratio of the nominal thickness of the central zone of the gasket divided by a minimum squeezing height between the male and female parts may typically be less than 1, preferably lying in the range 0.85 to 0.95;

if the pressure of the outside medium is greater than the pressure of the fluid, the gasket may be mounted on the male part with extension lying in the range about 1% to 5% relative to its nominal size; and

if the pressure of the fluid is greater than the pressure of the outside medium, the gasket may be mounted on the female part with peripheral compression lying in the range about 1% to 3% relative to its nominal size; and/or

the gasket may present a maximum squeezing width, and the ratio of the maximum squeezing width divided by the width of the groove being less than 1, preferably lying in the range 0.75 to 0.85.

The invention also provides the use of a gasket of the invention, for providing sealing between a chamber and a piston mounted to move in said chamber, wherein the gasket is mounted to be squeezed radially in a groove of the chamber, the groove being of determined height and depth, such that the lips are carried by the outside face and are in contact with the bottom of the groove, and the inside surface of the gasket is in contact with the piston.

According to preferred uses:

the ratio of the depth of the groove divided by a nominal transverse length of the gasket may typically be less than 1, preferably lying in the range 0.75 to 0.95;

the inside face may be plane and substantially free of any mold-parting plane flash;

each side face may carry a lobe arranged in such a manner that a space is provided between said at least one lobe and a corresponding one of the lips so as to enable the lobe to be compressed by material creep, the lobe being placed to extend the inside face;

said at least one lobe may present a side face that is substantially parallel to the edges of the groove; and/or

the ratio of the height of the groove divided by the sum of the nominal heights of the lips may typically be less than 1, preferably lying in the range 0.6 to 0.85.

### BRIEF DESCRIPTION OF THE DRAWINGS

Other characteristics of the invention appear from the following detailed description made with reference to the accompanying drawings in which:

FIG. 1 is a diagrammatic fragmentary cross-section of a first embodiment of a gasket of the present invention;

FIG. 2 is a diagrammatic cross-section view of a FIG. 1 gasket mounted between two mechanical parts, one male the other female, in a first use;

FIG. 3 is a diagrammatic view of a detail of FIG. 2;

FIG. 4 is a diagrammatic fragmentary cross-section view of a second embodiment of a gasket of the present invention;

FIG. 5 is a diagrammatic fragmentary cross-section view of a third embodiment of a gasket of the present invention;

FIG. 6 is a diagrammatic fragmentary cross-section view of a fourth embodiment of a gasket of the present invention;

FIG. 7 is a diagrammatic fragmentary cross-section view of a fifth embodiment of a gasket of the present invention;

FIG. 8 is a diagrammatic fragmentary cross-section view of a sixth embodiment of a gasket of the present invention;

FIGS. 9 and 10 are diagrammatic cross-section views of a FIG. 8 gasket shown between a chamber and a piston in a second use;

FIG. 11 is a diagrammatic fragmentary cross-section view of FIG. 10, showing the main tension stresses to which the gasket is subjected; and

FIG. 12 is a diagrammatic fragmentary cross-section view of FIG. 10 showing the main compression stresses to which the gasket is subjected.

### MORE DETAILED DESCRIPTION

In the description below, the following terms are defined as follows:

annular gasket: a gasket in the form of a solid of revolution, where the revolution may be elliptical, circular, polygonal, etc., about an axis of revolution situated at the center of the gasket;

bending zone: a zone of the gasket that can be moved under the effect of a force;

axis of revolution (R)=axis of revolution of the gasket;

transverse axis (T)=axis perpendicular to the axis of revolution;

cross-section=a section containing a transverse axis and the axis of revolution;

the height of a gasket element is the distance between the highest point of said element and the transverse axis of the gasket; and

“nominal” size (width, length, thickness, height, etc.): the size (width, length, thickness, height, etc.) at rest, when the gasket is not in use.

The gasket described below is made of an elastically deformable material. The material of the gasket may preferably be selected from polymer materials, in particular FPM (fluorocarbon rubber), HNBR (hydrogenated nitrile butadiene rubber), AEM (ethylene comethyl acrylate), ACM (a copolymer of ethylacrylate (or some other acrylate), and a copolymer providing reactive sites for vulcanization), NBR (nitrile rubber), and EPDM (terpolymer of ethylene, propylene, or a diene).

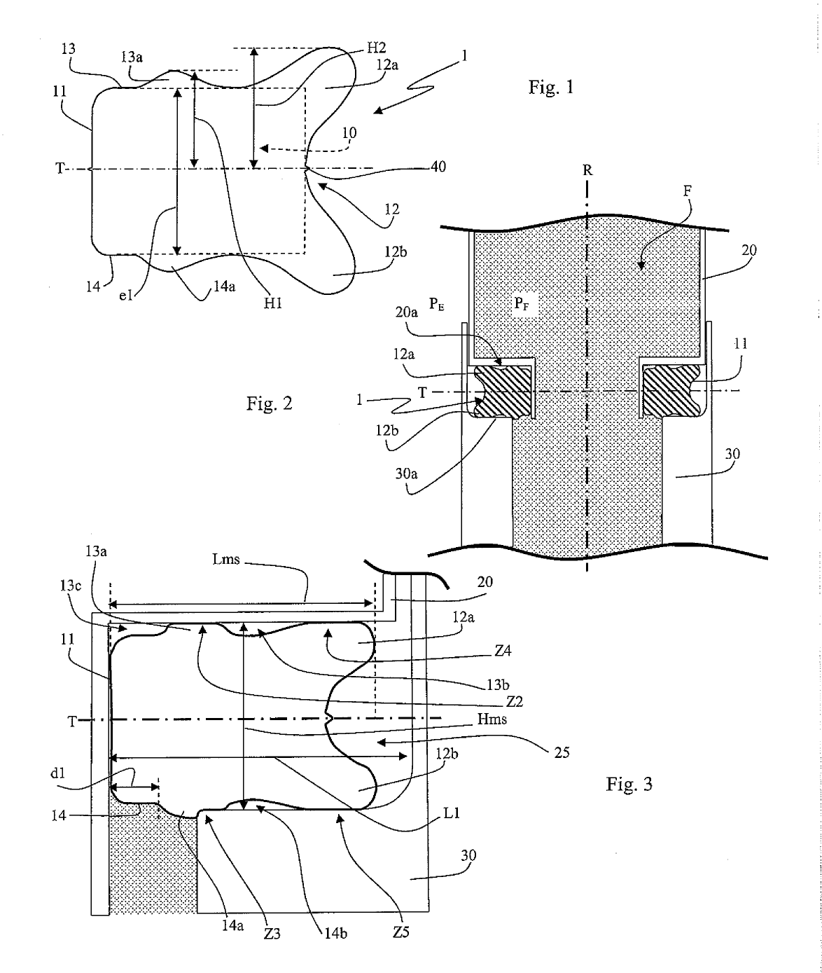

A first embodiment of a gasket of the invention, shown in FIG. 1, comprises in cross-section a central zone 10 of determined thickness e1. This central zone 10 presents an inside face 11 facing towards the axis of revolution R of the gasket 1 (see FIG. 2), and an outside face 12, opposite from the face 11 and thus facing towards the outside of the gasket. The inside and outside faces 11 and 12 are connected together by two side faces 13 and 14 that extend on either side of a transverse axis T of the gasket 1.

In this embodiment, each side face 13 or 14 includes a respective compressible lobe 13a, 14a. In addition, the outside face 12 carries two deformable lips 12a and 12b that are arranged on either side of the transverse axis T, each being connected to a respective side face 13a or 14a. Thus, each lip extends a respective one of the side faces.

Only one of the outside and inside faces 12 or 11 carries two lips.

In this embodiment, each lobe presents a nominal height H1 relative to the transverse axis T of the gasket 1, which height is less than the nominal height H2 of the lips relative to the transverse axis T of the gasket 1.

FIG. 2 shows an example of an assembly in which the FIG. 1 gasket is squeezed axially between a male part 20 and a female part 30 of a device for connecting together two fluid pipes F placed in an outside medium at a determined pressure P_{E}. The fluid F flows between these parts at a pressure P_{F}.

In this example, the fluid pressure P_{F} is selected to be less than the pressure P_{E} of the outside medium. For example, the outside medium is an outside fluid at a pressure P_{E}. In this pressure configuration, the two lips 12a and 12b are carried by the outside face 12 and they come into contact with the female part 30. The inside face 11 of the gasket 1 is placed against the bottom of the open groove 20a in the male part 20 to be squeezed axially against a shoulder 30a of the female part 30, i.e. substantially parallel to the axis of revolution R.

If the fluid pressure P_{F} is selected to be higher than the pressure P_{E} of the outside medium, then the two lips 12a and 12b are carried by the inside face 11 and they are in contact with the bottom of the open groove 20a in the male part 20. The outside face 12 may be in contact with the female part 30.

During assembly, the parts 20 and 30 are moved towards each other parallel to the axis of revolution R. The lips 12a and 12b deform and come closer to the transverse axis T of the gasket. In so doing, two lines of sealing are created even before the gasket is fully in its utilization position. When the lips 12a and 12b are deformed sufficiently for the parts 20 and 30 to come into contact with the lobes 13a and 14a, a stage of compressing these lobes begins, until the parts 20 and 30 are at a minimum distance for squeezing and are held at this distance in a utilization position. Preferably, the size of the gasket 1, the nominal height of the lobes 13a and 14a, and the nominal height of the lips 12a and 12b are selected so that the central zone 10 of the gasket 1 is not compressed when the parts 20 and 30 are fastened one against the other in the utilization position. Thus, the thickness of the central zone of the gasket is selected so that the ratio of said thickness e1 over the squeezing height Hms when squeezed is less than 1, and preferably lies in the range 0.85 to 0.95.

Similarly, the groove 20a presents a width L1 greater than the maximum width Lms of the gasket 1 when squeezed so as to ensure that the gasket is optimally positioned and so as to ensure that the lips 12a and 12b are deformed effectively. Thus, the lips of the gasket are dimensioned in such a manner that the ratio of the maximum width Lms when squeezed divided by the width L1 of the groove in which the gasket is to be mounted is less than 1, and preferably lies in the range 0.75 to 0.85. This ratio needs to be adjusted for each application as a function of the dimensional constraints of the assembly.

In the present description, the maximum width Lms when squeezed is the distance between the inside face 11 of the gasket and the outside ends of the lips as projected onto the transverse axis T of the gasket when the two mechanical parts are spaced apart by a minimum height when squeezed, which height is such that the central portion of the gasket is not compressed.

According to the invention, the distance between the lobes and the lips is selected so that, during compression, the material constituting the lobes can creep freely into the spaces 13b and 14b located respectively between each lobe 13a and 14a and the corresponding lip 12a or 12b. Thus, little or no compression is transmitted to the central zone 10 of the gasket, while nevertheless providing an extended sealing zone.

The lobes are preferably placed at a minimum nominal distance d1 from the inside face 11. This distance d1 is selected to ensure that the lobe 14a is not jammed in the clearance 25, where the clearance is needed to enable the two mechanical parts 20 and 30 to be assembled together easily.

The gasket of the invention thus presents five contact zones, namely, in the example shown in FIGS. 1 and 2: the contact zone Z₁ between the substantially plane inside face 11 and the part 20; the contact zones Z₂ and Z₃ between the lobes 13a and 14a and the parts 20 and 30, respectively; and the contact zones Z₄ and Z₅ between the lips 12a and 12b and the parts 20 and 30, respectively. The contact area between the gasket and the parts 20 and 30 is greater than the area that would be obtained using an O-ring, for example.

The zone Z₁ is a zone in which the gasket is lightly compressed due to the gasket being extended. The main function of the zone Z₁ is to ensure that the gasket is properly positioned in the groove 20a, however Z₁ does also contribute to sealing and thus to improving leaktightness.

The zones Z₂ and Z₃ are compression zones, where the force of interaction between the gasket and the mechanical part is considerable. The fluid F is prevented from leaking by the material creeping under the effect of being compressed into the roughness of the surfaces of the parts 30 and 20 forming the groove.

The zones Z₄ and Z₅ are bending zones of the gasket, where the force of interaction between the gasket and the parts 20 and 30 is less than in the zones Z₂ and Z₃. Nevertheless, this can be compensated by dimensioning the lips in such a manner that the contact area is greater in the zones Z₄ and Z₅ than in the zones Z₂ and Z₃ so as to ensure likewise good leaktightness, but without that leading to the parts 20 and 30 being deformed. In addition, these zones Z₄ and Z₅ are on the side of the gasket where the fluid pressure is the greater. Thus, in the example shown in FIG. 2, the gasket is shaped for mounting in a situation where the pressure P_{E} of the outside medium is selected to be greater than the pressure P_{F} of the fluid F. By way of example, the outside medium may be constituted by an outside fluid.

The spaces 13b and 14b perform a buffer role that improves the leaktightness of the gasket. Should any outside fluid manage to diffuse between the part 30 and the lip 12b, it begins by filling the space 14b before it can diffuse under the lobe 14a, since the pressure of the outside fluid within the space 14b is lower than the pressure of the outside fluid in the clearance space 25. The diffusion of outside fluid into the zone Z₅ is limited.

Similarly, if the outside fluid manages to diffuse between the part 20 and the lip 12a through the bending zone Z₄, it begins by filling the space 13b before it can manage to diffuse between the lobe 13a and the part 20 via the compression zone Z₂. If in spite of everything the outside fluid manages to diffuse through the zone Z₂ it begins by filling the space 13a before it can diffuse between the inside face 11 and the part 20 via the lightly compressed zone Z₁ and thus contaminate the inside fluid F at lower pressure P_{F}.

The combination of the compression zones Z₂ and Z₃ with the bending zones Z₄ and Z₅ serves to improve the leaktightness of the gasket, while making it easier to squeeze the gasket and assemble the mechanical parts 20 and 30 together. The force needed for deforming the lip is less than the force needed for compressing the lobes.

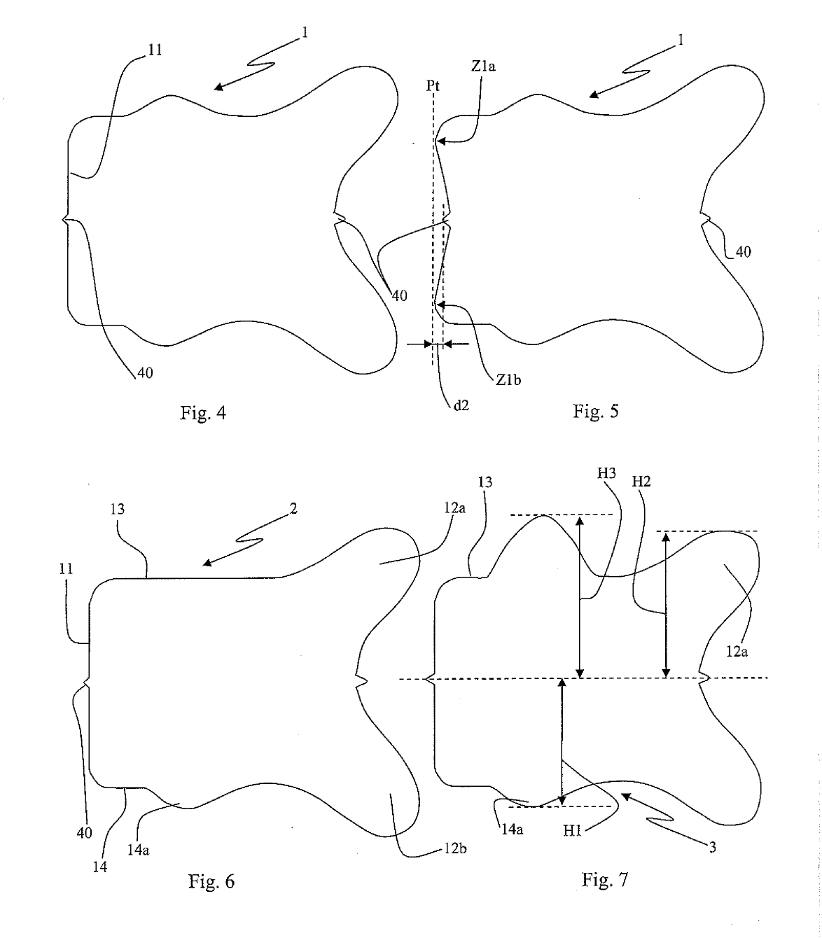

In the embodiment shown in FIG. 4, the gasket 1 carries flash 40 in the mold-parting plane, where such flash constitutes an inevitable fabrication defect.

By opting to fabricate the gasket with the help of a two-part mold so that the flash 40 is substantially parallel to the transverse axis T, the flash can be located away from the compression zones Z₂ and Z₃ and the bending zones Z₄ and Z₅, and thus in a portion of the gasket that has no functional role. Greater tolerance can thus be allowed for the flash, thereby reducing fabrication costs. The use of a two-part mold also presents an economic advantage. The transverse axis T is preferably in the mold-parting plane, such that the flash 40 is aligned on the transverse axis T, thereby facilitating unmolding. The lips 12a and 12b are thus disposed on either side of the mold-parting plane.

When the gasket 1 is mounted in a manner similar to the mounting shown in FIG. 2, it may be desirable for the flash in the mold-parting plane not to hinder pressing of the inside face 11 of the gasket against the bottom of the grove 20a in the part 20. For this purpose, the embodiment shown in FIG. 5 presents a gasket 1 with an inside face 11 that is concave such that the flash 40 does not project beyond the zones Z₁ₐ and Z_{1b} via which the inside face 11 is pressed against the part 20. The flash 40 is preferably situated at a minimum distance d2 from the plane P that is tangential to the zones Z₁ₐ and Z_{1b}. In this embodiment, stretching of the gasket can be greater, and as a result contact pressures can be increased in the zones Z₁ₐ and Z_{1b}, while also creating an additional buffer zone for braking the diffusion of the outside fluid, and thus further increasing leaktightness.

In the embodiment shown in FIG. 6, the gasket 2 may have only a single side face 14 that presents a lobe 14a. Thus, in a mounting similar to that shown in FIG. 2, the gasket 2 shown in FIG. 6 provides only one space 13c between the side face 13, the part 20, and the lip 12a. As explained with reference to FIGS. 2 and 3, this space performs the role of a buffer.

In order to ensure that the gasket 2 opposes passage of the outside fluid between the part 20 and the inside face 11, the gasket may be mounted on the part 20 with extension of the order of 1% to 5% relative to its nominal size. This mounting in extension may be performed for all of the embodiments shown in FIGS. 1 to 7. Thus, the gasket is pressed against the part 20 via its face 11. In order to ensure that the flash 40 does not impede this pressing, it is also possible to make provision for the gasket 2 to present an inside face 11 that is concave, as shown in FIG. 5. Some minimum amount of extension is desirable in order to ensure that the gasket is positioned effectively.

More generally, if the pressure P_{E} of the outside medium is greater than the pressure P_{F} of the fluid, the gasket is mounted on the male part 20 with extension lying in the range approximately 1% to 5% relative to its nominal size. However, if the pressure P_{F} of the fluid is greater than the pressure P_{E} of the outside medium, then the gasket is mounted on the female part 30 with peripheral compression lying in the range approximately 1% to 3% relative to its nominal size.

In another embodiment, the gasket may be designed to favor compression forces over bending forces. This embodiment is shown in FIG. 7 where the gasket 3 presents, on one of its side faces 13, a lobe 13a of height H₃ that is greater than the height H₂ of the lip 12a, and on its other side face 14, a lobe 14a of height H₁ less than the height H₃ of the lobe 13a. In general, the gasket of the invention may include at least two lobes of different heights that are greater than or less than the H₂ of the lips.

By means of the gasket of the invention, the contact area between the mechanical parts 20 and 30 and the gasket 1, 2, or 3, is greater than in a prior art gasket for given squeezing force. This gives rise to better leaktightness performance without causing the parts 20 and 30 to be deformed, as when these parts are made of plastics material. In addition, this greater squeezing in the compression zones Z₂ and Z₃ and in the bending zones Z₄ and Z₅ improves the leaktightness of the gasket compared with prior art gaskets.

Finally, the forces needed to squeeze the gasket are smaller and the risk of plastic deformation of the elements making up the groove is reduced compared with prior art gaskets.

The gasket of the invention also makes it possible to provide sealing between parts with slack tolerances concerning dimensions, shape, or positioning of the elements making up the groove in which the gasket is placed. Thus, the width, the height, and the distance of the lobes from the inside face 11 can be dimensioned in such a manner as to ensure that sealing is provided between two parts over a wide range of tolerance and clearance between the two parts. In other words, the positioning of the lobe is adapted to provide sealing between the two mechanical parts at determined positions that are themselves remote from the clearance spaces between the parts. The portions of the gasket that serve to provide sealing are thus situated away from the clearance spaces, such that the real contact lengths between the gasket and the mechanical parts are optimized compared with known gaskets.

Furthermore, once their positions have been selected, the nominal height of the lobes can be adapted to the mechanical strength to the parts. Thus, if a lobe is situated in a zone where one of the parts presents low strength (for example the plane zone of the part 20 facing the zone Z₂ in FIG. 3), the nominal height of the lobe may be low enough to ensure sealing while limiting the stress against the part. In contrast, if the lobe is situated in a zone where one of the parts presents great strength (the angle of the part 30 facing the zone Z₃ in FIG. 3), then the nominal height of the lobe can be greater so as to increase the compression force and thus increase leaktightness. The same goes for the dimensioning of the lips to achieve greater contact area while reducing compression forces. The nominal height of each lip may also be adapted.

Finally, in an assembly where squeezing is axial, the gasket of the invention is not sensitive to the tipping or roll-back phenomenon.

The gasket of the invention can also be used to provide sealing in an actuator between a chamber and a piston mounted to move in the chamber, e.g. for a braking application.

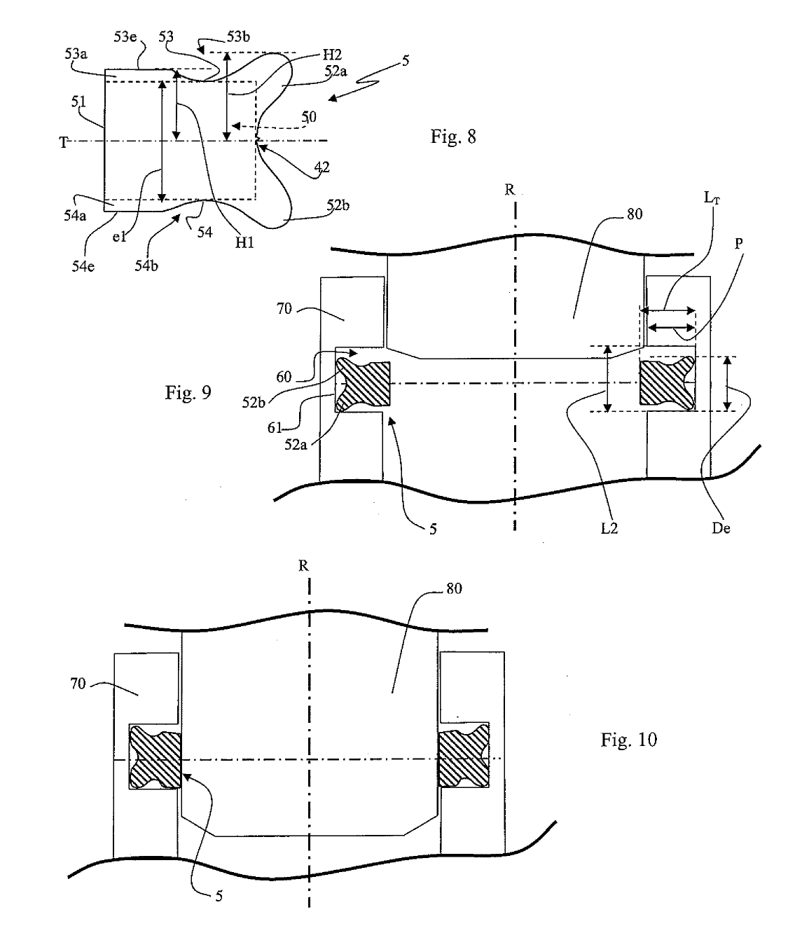

In the embodiment shown in FIG. 8, the gasket 5 is preferably adapted to maximize contact length between the gasket and the piston. Thus, each side face 53 and 54 carries a respective lobe 53a or 54a extending the inside face 51. In this embodiment, there is thus no minimum distance between each lobe 53a or 54a and the inside face 51.

In addition, each lobe 53a and 54a is arranged in such a manner that a space 53b or 54b is provided between said lobe 53a or 54a and one of the lips 52a or 52b so as to enable the lobe to be compressed by material creep.

The use of such a gasket is shown in FIGS. 9 and 10. The gasket 5 is mounted to be squeezed radially in a groove 60, of determined height L2 and of determined depth P, in the chamber 70. The lips 52a and 52b are designed to come into contact with the bottom 61 of the groove 60, and the inside face 51 of the central zone 50 is designed to come into contact with the piston 80.

The inside face 51 is preferably plane and substantially free of any mold-parting plane flash. It is possible to use a cryogenic method on the flash to achieve this. The term “free” is used to mean that the gasket is fabricated without flash or that it is subjected to an operation of flash removal, within the tolerance limits of fabrication methods and at reasonable expense for industrial production of gaskets. In other words, the inside face 51 may have some flash residue or flash that is very small and that does not hinder the gasket being pressed against the piston 80.

The ratio of the depth P of the groove over the nominal transverse length L_{T} of the gasket is typically less than 1, preferably lying in the range 0.75 to 0.95.

Preferably, the lobes 53a and 54a present respective side faces 53e and 54e that are substantially parallel to the edges of the groove. This avoids the gasket twisting when the piston 80 slides in the chamber 70.

Thus, under the action of hydraulic pressure, the piston 80 moves and entrains the gasket which deforms in the travel direction of the piston.

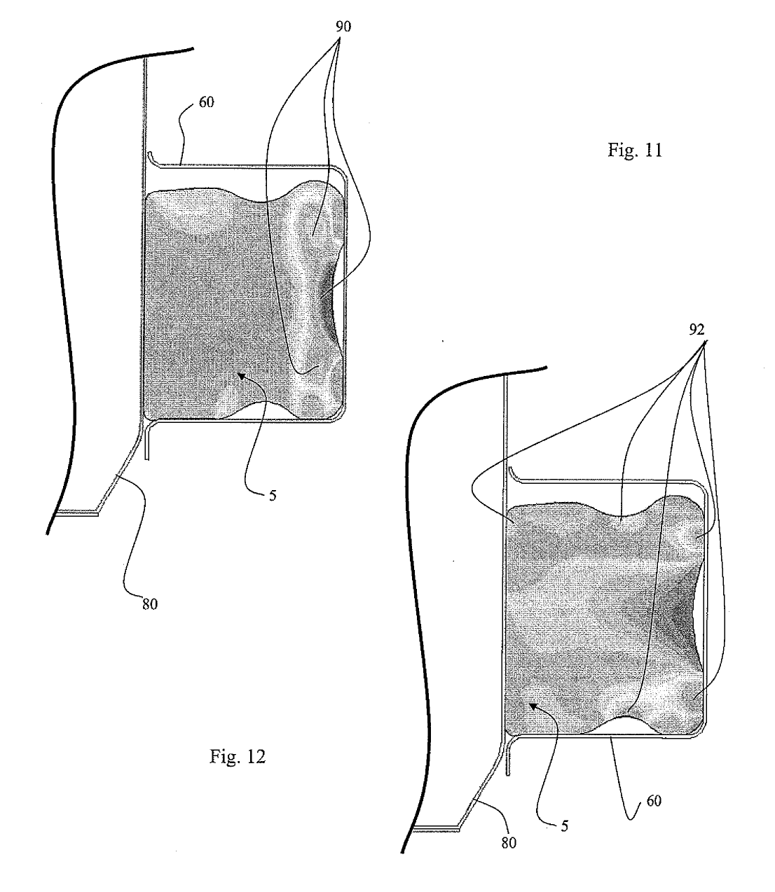

As shown in FIGS. 11 and 12, some portions of the gasket are stretched: portions 90 in FIG. 11; whereas other portions are compressed: portions 92 in FIG. 12.

When the pressure decreases, the solid rectangular zone formed by the faces 53e, 54e, and 11 ensures that the gasket is restored elastically. The gasket thus returns to its initial position and entrains the piston with it. This ensures that the piston is returned.

Depending on the material selected, and thus on its mechanical characteristics (elongation, ultimate tensile strength, tearing strength, etc.), it is possible to optimize the operation of the gasket by increasing or decreasing its solid zone constituted by the lobes 53a, 54a and by the central one 50. For example, a material having hardness of 60 on the Shore scale deforms more under the action of pressure, but deformation energy is smaller and the phenomenon of resilient return of the gasket is also smaller.

With increasing pressure, it is necessary for the hardness of the gasket to be increased. Nevertheless, its hardness must not prevent the gasket from deforming, since that would present resilient return of the piston. For example, for a pressure of 70 bars, hardness lying in the range 70 to 75 on the Shore A scale is appropriate.

Preferably, the lips 52a and 52b are stiffer than in the above-described piston use, so as to be able to withstand high pressures (100 bars to 140 bars) while still ensuring return of the piston. To increase the stiffness of the lips, it is possible to increase the section of the lips, to reduce the depth of the space between the lips, and/or to reduce the depth of the spaces 53b and 54b.

The lips 52a and 52b of the gasket serve to reduce engagement forces and to ensure that the gasket is properly positioned.

The spaces 53b and 54b enable the lips 52a and 52b to deform during the squeezing stage.

The space between the lips 52a and 52b ensures that the gasket is properly positioned.

Preferably, the faces 53e and 54e are connected to the face 51 via radii that are very small. This is advantageous both technically (to avoid appearance defects on the parts during unmolding) and economically (to facilitate making the tooling).

The ratio of the height of the groove L2 over the sum De of the nominal heights H2 of the lips 52a and 52b may typically be less than 1, preferably lying in the range 0.6 to 0.85. Under such circumstances, the height De of the outside edge of the gasket is thus slightly greater than the length L2 of the groove, thereby enabling the gasket 5 to be pressed against the groove and preventing it from twisting while the piston is sliding.

Thus, with a gasket of the invention, it is possible to solve both the technical problem of sealing a connector and of returning a hydraulic piston. This is made possible by the structure of the gasket and by the way in which it is mounted.

In a mounting for axial squeezing, the gasket of the invention is not sensitive to the roll-back phenomenon and it makes it possible significantly to increase the leaktightness of connectors while reducing the force needed to engage the connector parts.

In a mounting for radial squeezing, the gasket of the invention provides sealing for the assembly by means of the deformability of the lips 52a and 52b, and the large contact area constituted by the inside surface 51 and the edges of the lobes extending said surface 51, while limiting compression forces. In addition, it performs a function of resiliently returning the piston into the chamber.

In other embodiments:

the gasket may be asymmetrical about the transverse axis, and in particular one of the side faces may be oblique relative to the transverse axis; and

each side face may have a plurality of lobes, possibly of different sizes, so as to increase the number of contact zones and buffer zones so as to improve the sealing of connectors.

What is claimed is:

1. An annular gasket of elastically deformable material presenting an axis of revolution and a transverse axis, and comprising, in cross-section, a central zone of determined thickness, presenting an inside face facing towards the axis of revolution, an outside face opposite therefrom, and two side faces interconnecting the inside and outside faces, wherein:
at least one of the side faces includes at least one compressible lobe; and
one of the outer and inner faces carries two lips suitable for bending that are arranged on either side of the transverse axis and each of which is connected to a respective one of the side faces.

2. An annular gasket according to claim 1, wherein the inside face carries the two lips suitable for bending that are arranged on either side of the transverse axis and each of which is connected to a respective one of the side faces.

3. An annular gasket according to claim 1, wherein the outside face carries the two lips suitable for bending that are arranged on either side of the transverse axis and each of which is connected to a respective one of the side faces.

4. A sealing gasket according to claim 1, wherein both lips and said at least one lobe present respective determined nominal heights relative to the transverse axis of the gasket, the nominal height of at least one of the lips being greater than the nominal height of said at least one lobe.

5. A sealing gasket according to claim 1, having at least two lobes of different heights.

6. A sealing gasket according to claim 1, wherein each side face carries a respective lobe arranged so that a space is provided between the lobe and a respective one of the lips so as to enable the lobe to be compressed by material creep.

7. A sealing gasket according to claim 1, wherein said at least one lobe is located at a determined minimum distance from the inside or outside face that does not carry the lips.

8. A sealing gasket according to claim 1, including flash in a mold-separation plane, the flash being disposed substantially parallel to the transverse axis of the gasket.

9. A sealing gasket according to claim 1, wherein the inside or outside face that does not carry the lips is substantially plane.

10. A sealing gasket according to claim 1, wherein the inside or outside face that does not carry the lips is concave.

11. The gasket according to claim 1, in combination with a device for connecting together two pipes for a fluid at a determined pressure, the pipes being placed in an outside medium at a predetermined pressure, the connection device comprising a male part and a female part, wherein the gasket is mounted to be squeezed axially in a groove of determined width in the male part, in such a manner that:
if the pressure of the outside medium is greater than the pressure of the fluid, the two lips are carried by the outside face and the inside face is in contact with the bottom of the groove in the male part; and
if the pressure of the fluid is greater than the pressure of the outside medium, the two lips are carried by the inside face and are in contact with the bottom of the groove in the male part.

12. The device according to claim 11, wherein the ratio of the nominal thickness of the central zone of the gasket divided by a minimum squeezing height between the male and female parts is typically less than 1, preferably lying in the range 0.85 to 0.95.

13. The device according to claim 11, wherein:
if the pressure of the outside medium is greater than the pressure of the fluid, the gasket is mounted on the male part with extension lying in the range about 1% to 5% relative to its nominal size; and
if the pressure of the fluid is greater than the pressure of the outside medium, the gasket is mounted on the female part with peripheral compression lying in the range about 1% to 3% relative to its nominal size.

14. The device according to claim 11, wherein the gasket presents a maximum squeezing width, and the ratio of the maximum squeezing width divided by the width of the groove is less than 1, preferably lying in the range 0.75 to 0.85.

15. The gasket according to claim 3, mounted for providing sealing between a chamber and a piston mounted to move in said chamber, wherein the gasket is mounted to be squeezed radially in a groove of the chamber, the groove being of determined height and depth, such that the lips are carried by the outside face and are in contact with the bottom of the groove, and the inside surface of the gasket is in contact with the piston.

16. The apparatus according to claim 15, wherein the ratio of the depth of the groove divided by a nominal transverse length of the gasket is typically less than 1, preferably lying in the range 0.75 to 0.95.

17. The apparatus according to claim 15, wherein the inside face is plane and substantially free of any mold-parting plane flash.

18. The apparatus according to claim 15, wherein each side face carries a lobe arranged in such a manner that a space is provided between said at least one lobe and a corresponding one of the lips so as to enable the lobe to be compressed by material creep, the lobe being placed to extend the inside face.

19. The apparatus according to claim 15, wherein said at least one lobe presents a side face that is substantially parallel to the edges of the groove.

20. The apparatus according to claim 15, wherein the ratio of the height of the groove divided by the sum of the nominal heights of the lips is typically less than 1, preferably lying in the range 0.6 to 0.85.
